(19) United States
(12) Patent Application Publication
(10) Pub. No.: US 2009/0211527 A1
(43) Pub. Date: Aug. 27, 2009

(54) Providing A Human-Sized Milking Passageway Inside A Circular Turntable

(75) Inventors: Jean-Yves Binet, Guilberville (FR); Fabrice Beausire, Beubrigny (FR); Stephane Lebarillier, Guiberville (FR)

Correspondence Address: BRIGGS AND MORGAN P.A., 2200 IDS CENTER, 80 SOUTH 8TH ST, MINNEAPOLIS, MN, 55402, US

(73) Assignee: S.A. BINET, Guilberville (FR)

(21) Appl. No.: 11/920,224

(22) PCT Filed: May 10, 2006
(86) PCT No.: PCT/FR2006/001032

§ 371 Date: Jan. 30, 2009

(30) Foreign Application Priority Data
May 12, 2005 (FR) 0504763

(51) Int. Cl. A01K 1/12

(52) U.S. Cl. 119/14.04

(57) ABSTRACT

The present invention relates to a milking facility provided inside a milking parlour circular turntable (2) provided with stalls (20) in which cows can be milked from the side or from behind, characterised in that each of the stalls (20) is provided with an individually openable gate (12), one or more human-sized passageways (13) provided on the turntable each replace one stall and are stall-sized and protected by a stationary barrier (14) as well as a pivotable barrier (16) enabling a cow to be led into the stall (20), whereafter the passageway (13) is cleared of obstacles, and a pit ladder (17) making it easier for a person to move along the passageway (13) and into the milking pit (3).

The present invention concerns an arranged device, put in place in the stalls for a milking hall with a rotary circular platform, commonly referred to as a milking parlour, equipped with stalls allowing milking at the side or from the rear of the cows. This invention applies in the case where the milking takes place inside this platform, in the milking pit, situated below it, at a height of approximately one metre. The invention thus allows free circulation from outside the parlour onto the platform, and then into the pit, and vice-versa, without any obstacle to be passed.

In the prior art, accessibility from outside to inside the platform and vice-versa takes place either:

1—Through an underground passage (4), arranged in the foundations of the milking room, passing under the paving of the platform running track, thus allowing secure access in the milking pit (3). However, this solution is very little used because of its excessively high cost over the whole of the construction process.

2—Through the passage through the cattle restraint stalls, under highly acrobatic and rather unsafe conditions, of the persons wishing to go inside the milking parlour (—Entry onto the platform through the cattle access door (10 & 11), —passing under or between the front restraint bars (5), and then opening the rear cattle restraint bars provided for this purpose in order to pass them and descend into the pit by a staircase fixed to the floor from the rotating platform). Exiting takes place in the reverse order and just as dangerously under the same conditions.

The accompany drawings illustrate:

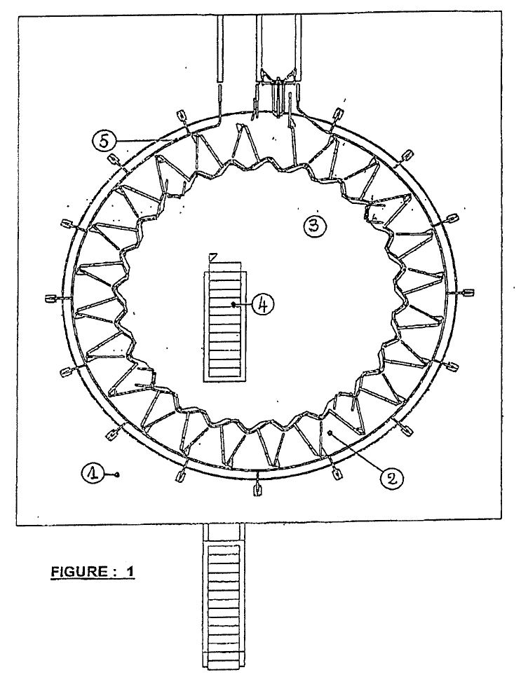

FIG. 1: Plan view of the current milking parlour with the Front Rail (5) obstructing the manway, and the underground passage (4) mentioned above.

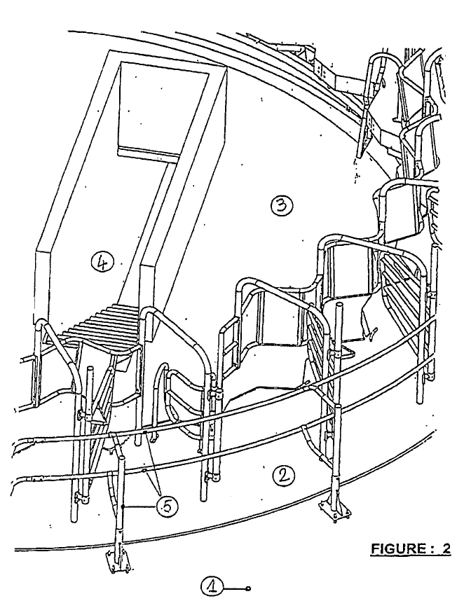

FIG. 2: Current general view of the outside of the milking parlour showing the underground passage (4) in the milking pit (3) and the Front Rail (5) situated on the periphery of the platform, fixed to the external paving (1), the latter being at the same level as the platform (2).

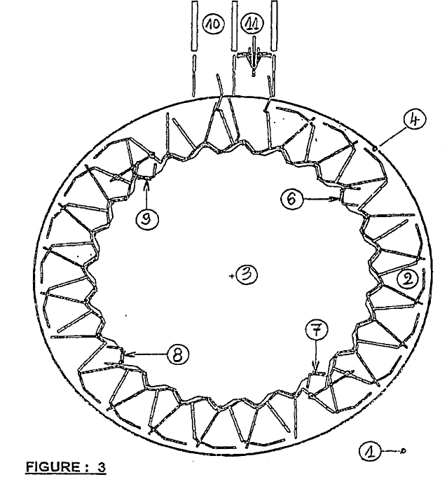

FIG. 3: Plan view of the milking parlour according to the invention with indication on the platform (2) of the four points (6, 7, 8 & 9) where men can pass from the pit (3) to the outside of the parlour (1) and the arrangement of these four passages without any obstacle.

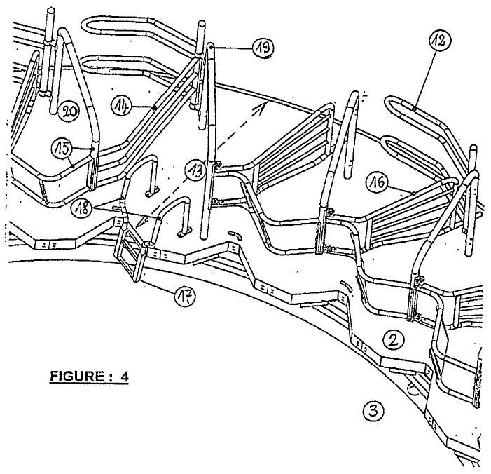

FIG. 4: General view, according to the invention, of a manway (13) arranged on a rotary circular platform (2).

On the majority of milking parlours constructed at the present time, there is a Front Rail (5) composed of two circular bars, fixed to the slab (1) external to the rotary platform, superimposed at approximately 750 and 1300 mm above this platform (2), with an open passage for the entry (11) and exit (10) of the cattle, in front of the animal loading platform. This double bar (5) locks the cows in the milking position (their head being situated between the two bars) but is also an obstacle to be passed for access to the platform (2), which can be done only by passing under or between the bars.

The advantage of the invention lies in the elimination of this Front Rail (5) in order not to encumber the passage (13) of the milker or milkers and any person needing to go into the milking pit (3). It has therefore been replaced by an individually opening Rail Door (12) installed on all the milking stalls, except at the points where the manways (13) are situated.

The manway (13) in itself is protected by mounting, on one side, of a fixed low-sided barrier (14), bolted between two arches installed to support the milking stalls, running from the rear restraint (15) for the cow to the following arch (19), the support for the Door Rail (12), and, on the other side, of an opening barrier (16) allowing, in the open position, the entry of the cattle onto the platform (2) at the moment when the milking parlour passes in front of the loading dock (11). Once the cow is in the milking position in its stall, the barrier closes again on the cow in order to lock it during the milking, at the same time leaving the manway (13) clear of any obstacle.

Descent into the milking pit (3) takes place easily by means of a pit staircase or ladder of the “swimming pool” type (17), with handrail (18), fixed to the platform (2). The handrails (18) make it possible to hold on tight in order to pass from a step in rotation movement to a fixed floor and vice-versa, in complete safety as on an escalator.

In FIG. 3, we have positioned four passages (6, 7, 8 & 9) which, sized, can be replaced by milking stalls (20), in the case of a frequent increase in the number of cows to be milked or for a saving in milking time which had not been judged necessary at the time of installation of the milking parlour. This therefore gives us a possibility of extension of the number of milking stations on the parlour.

However, it will be necessary to keep at a minimum one passage (13) in order to be able to get out of the milking pit. These passages will be uniformly distributed over the periphery of the parlour at 180° for two manways, at 120° for three manways and 90° for four manways.

This type of passage (13) makes it possible to gain access quickly in complete safety: either to the pen where the cows are situated waiting for the milking, or to any other annexe of the milking unit.

1) Milking parlour with a rotary circular platform (2) for milking inside this platform, equipped with stalls (20) allowing milking from the side or rear of the cows, characterised in that each of the stalls (20) is provided with an individually opening rail door (12), at least one manway (13) being provided on the platform each instead of a stall and each sized similarly to a stall, protected by a fixed barrier (14) and an opening barrier (16) as well as a pit ladder (17) facilitating passage of a man when descending into the milking pit.

2) Milking parlour with rotary circular platform (2), according to claim 1, characterised in that the platform (2) is provided with two manways (13) placed opposite each other on the platform, that is to say at 180°.

3) Milking parlour with a rotary circular platform (2), according to claim 1, characterised in that the platform (2) is provided with three manways (13) positioned uniformly over the periphery of the platform, that is to say at 120° with respect to one another.

4) Milking parlour with a rotary circular platform (2), according to claim 1, characterised in that the platform (2) is provided with four manways (13) positioned uniformly over the periphery of the platform, that is to say at 90° with respect to one another.

5) Milking parlour according to claim 1, characterised in that 1, 2, or 3 of these manways (13) can be converted into a milking stall (20).
